(19) United States
(12) Patent Application Publication
(10) Pub. No.: US 2010/0316374 A1
(43) Pub. Date: Dec. 16, 2010

(54) Networked mapping function

(75) Inventors: Laurence Henry Fingler, King City (CA); William Alexander Slater, Tottenham (CA); Hung Van Tran, Milton (CA)

Correspondence Address: DENNISON ASSOCIATES, 133 RICHMOND STREET WEST, SUITE 301, TORONTO, ON, M5H 2L7, CA

(73) Assignee: FIBER CONNECTIONS INC., Schomberg (CA)

(21) Appl. No.: 12/458,899

(22) Filed: Jul. 27, 2009

(30) Foreign Application Priority Data
Jun. 15, 2009 (CA) 2668976

(51) Int. Cl. H04B 10/08

(52) U.S. Cl. 398/15

(57) ABSTRACT

A fiber to copper patch terminal includes selectively activated circuitry for controlling an associated transceiver to produce a condition where normal communication with a connected power patch panel module has been temporarily interrupted. The patch terminal includes a selectively activated location identification function. This function when activated causes the optical transceiver to transmit a location signal preferably during a period where communication is awaiting resetting. In a preferred embodiment the patch terminal is designed to transmit the location signal during a period where Ethernet communication as awaiting completion of a reset.

### FIELD OF THE INVENTION

The present invention relates to fiber optic network systems, and in particular, to a system used to simplify the mapping of patch terminals relative to an upstream power patch panel.

### BACKGROUND OF THE INVENTION

There are many applications where it is common to have a fiber optic network system with a series of fiber to copper patch terminals provided at the downstream end of the system. The fiber to copper patch terminals allow users to connect to the system in a number of different ways. The fiber to copper patch terminals are connected to a power patch panel provided in a computer room, for example, by means of a multi-fiber cabling system. The power patch panel includes a plurality of patch panel modules in communication with particular patch terminals. Typically, this type of system operates using an Ethernet communication protocol, and the signals are converted by the fiber to copper patch terminal, and transmitted and received from the system. The patch terminals include a transceiver to receive and transmit signals over the fiber optic system.

In small network systems, it is relatively straightforward to map or to trace the actual cable connections between a fiber to copper patch terminal and a power patch panel provided at a central location. As the system expands, this problem becomes more difficult and it is often a key consideration whenever any difficulties occur with a system. In large networked systems, a detailed mapping arrangement is produced to allow a technician to trouble shoot the system more effectively. Unfortunately, such mapping procedures are often not maintained, or unauthorized changes to the system occur.

It would be desirable to have a simple arrangement for identifying or confirming the communication path between a fiber to copper patch terminal and a power patch panel provided upstream thereof.

### SUMMARY OF THE INVENTION

A fiber optic network system according to the present invention comprises a power patch panel connected to a series of fiber to copper patch terminals by fiber optic cabling. The power patch panel includes a plurality of patch panel modules and each module has a plurality of ports. Each port includes an indicator that is activated upon receipt of a location identification transmission signal originating from a connected patch terminal. Each patch terminal includes an optical transceiver that transmits and receives signals in accordance with a communication protocol that includes a non-transmit/receive period if a detected interruption in communication with the associated patch panel module occurs. Each patch terminal includes a selectively activated location identification function that when activated causes the patch terminal to produce a non-transmit/receive period recognized by the protocol. The location identification function causes the optical transceiver to transmit an identification signal. The power patch panel module, upon receipt of a location identification signal, produces a visual indication identifying the port that received the location identification signal. With this arrangement, a technician can cause the user patch terminal to transmit a location identification signal, and then inspect the power patch panel and determine the port used to communicate with the particular user patch terminal.

The power patch panel, as well as the user patch terminal, advantageously uses a characteristic of the communication protocol to transmit a location identification signal during a period where conventional signals between the power patch panel and the user patch terminal are being ignored. In a preferred embodiment, the non-transmit/receive period is repeatedly created whereby the communication protocol continues to ignore any signals for an extended period of time.

In a preferred embodiment of the invention, the power patch panel includes a light source associated with each port, and the light source is activated when a location identification signal is received by the respective port.

In a further aspect of the invention, the location identification function of each patch terminal includes a manual switch which produces the location identification signal when activated.

In a further aspect of the invention, the communication protocol used in the fiber optic network system is an Ethernet communication protocol.

In yet a further aspect of the invention, the communication protocol includes a resettable time interruption period where signals received by the user patch panel are not processed according to the communication protocol. The resettable time interruption period is initiated when an idle level of light is not received by the respective transceiver of either patch panel.

In yet a further aspect of the invention, the manual switch, when activated, causes the transceiver to pulse between states producing at least an idle level of light to a state not producing an idle level of light sufficient to maintain a state where signals of the transceiver are not processed using the communication protocol.

An improved fiber to copper patch terminal, according to the present invention includes an operating protocol controlling an optical transceiver for transmission and reception of signals and selectively activated circuitry to produce a condition where normal communication with a connected power patch panel module is temporarily interrupted. The circuitry during the interruption of normal communication causes the transceiver to transmit a location identification signal recognizable by the power patch panel module. Preferably the module produces a visual indication when a location identification signal has been received.

### BRIEF DESCRIPTION OF THE DRAWINGS

Preferred embodiments of the invention are shown in the drawings, wherein:

FIG. 1 is a schematic overview of a fiber optic network system;

FIG. 2 is a partial enlargement of the user patch terminal shown in FIG. 1;

FIG. 3 is a partial enlargement of the power patch panel module shown in FIG. 1;

FIG. 4 is a schematic view of a user patch terminal; and

FIG. 5 is a schematic view of additional circuitry provided for the power patch panel.

### DETAILED DESCRIPTION OF THE PREFERRED EMBODIMENTS

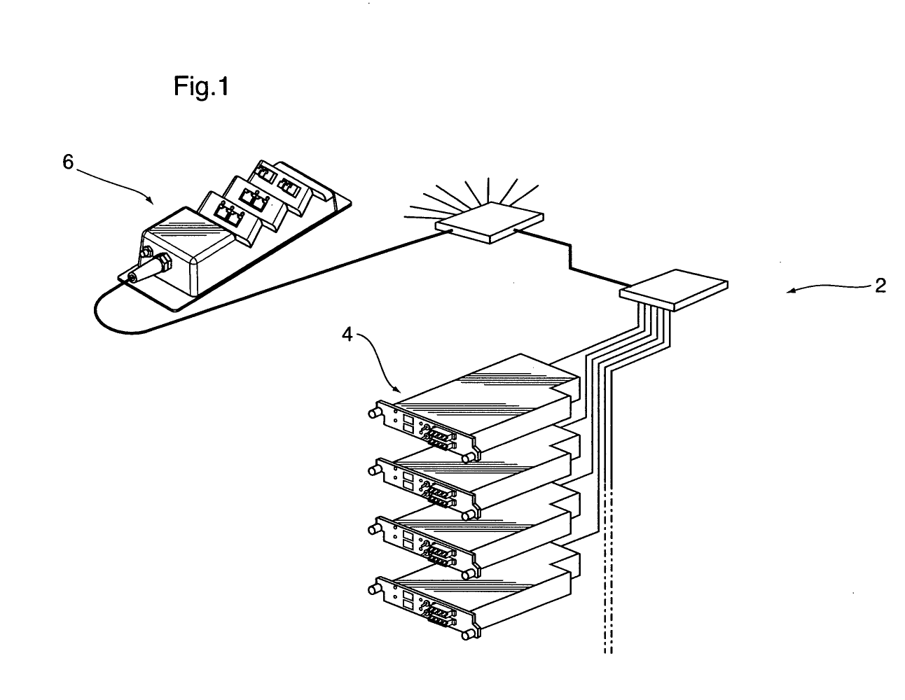

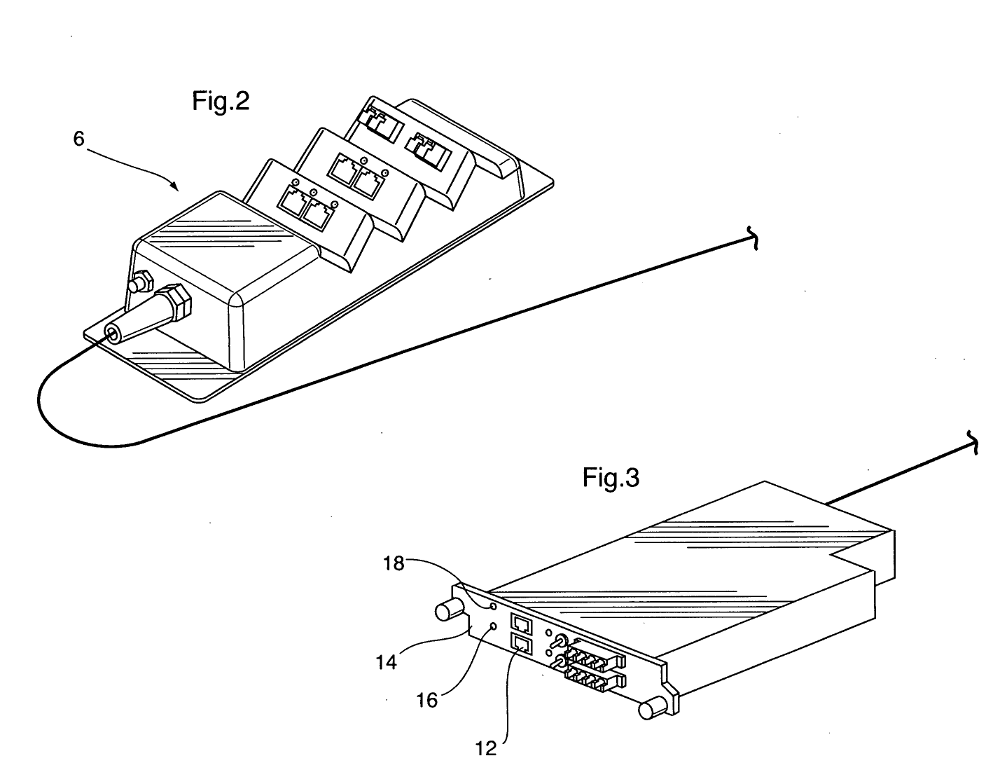

The fiber optic network system 2 shown in FIG. 1 illustrates a single power patch panel module 4; however in practice there will be a series of modules that are part of a power patch panel (not shown). FIG. 1 also illustrates a fiber to copper patch terminal 6; however the network would include a host of these patch terminals. Typically, the power patch panel module 4 is combined with other modules in a patch panel located in a computer room, and is connected to a high speed digital network. High speed multi-fiber optic cabling is provided between the power patch panel modules and the various user patch terminals 6. Each user patch terminal 6 includes a series of ports and these ports include Ethernet ports for connection to computer equipment and may additionally include fiber optic ports.

The communication protocol is typically an Ethernet communication protocol, and each patch terminal 6 converts signals and includes a transceiver for appropriately transmitting signals across the fiber network and receiving signals.

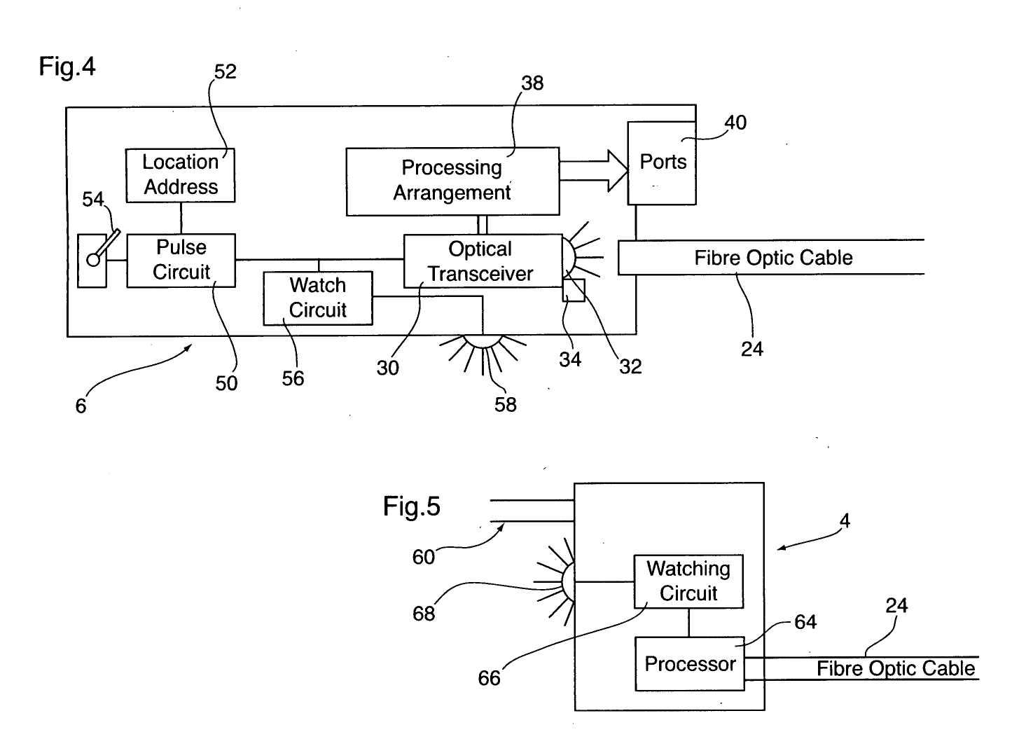

As shown in FIG. 3, the power patch panel module 4 is shown with two ports 12 and 14 with each port including a light emitting indicator 16 and 18 respectively. These light emitting indicators will be activated when a location signal is received by the particular port. This aspect will be further explained with respect to FIGS. 4 and 5.

FIG. 4 is a schematic that illustrates certain additional circuitry that is associated with the patch terminal 6. The patch terminal 6 includes an optical transceiver shown as 30 having a light transmission source indicated as 32 in combination with the receiver 34. With this arrangement, the transceiver 30 transmits signals to the fiber optic cable indicated as 24 and receives optical signals from the fiber optic cable. The Ethernet communication protocol used for transmission over the fiber optic network system 2 includes a time reset function in the event an idle level of light is not received by the transceiver 30. The protocol includes a certain time delay before attempting to re-establish communication. This feature of the protocol is used by the present system for transmitting a location identification signal.

As shown in FIG. 4, a manual switch 54 is shown that is used to activate the pulse circuit 50. The pulse circuit 50 is connected to the optical transceiver 30 and causes the transceiver to cycle between a transmission state where light is being transmitted by the transceiver to a non-active state where light is not being transmitted. The pulse circuit is such that it will maintain the protocol in a temporary suspension condition as an idle level of light is not being received. By pulsing the signal to the optical transceiver a pulse signal is transmitted over the fiber optic cable 24. This pulse signal can be an identification signal recognized by the power patch panel module, or the signal can also include details of a location address indicated as 52 shown in FIG. 4.

The pulse signal is received by the power patch panel module 4 over the fiber optic cable indicated as 24 in FIG. 5. This signal is processed by the processor 64 which also includes a watching circuit indicated as 66. The watching circuit is used to recognize a pulse location identification signal from a patch terminal, and when this particular signal has been recognized, the watching circuit will activate the mapping indicator shown as 68.

With this arrangement, a technician seeking to identify the particular port on the power patch panel module 4 that a particular user patch terminal 6 is connected to, can activate the manual switch 54 provided on the patch terminal 6. This activates the pulse circuit, and turns the optical transceiver 30 on and off. The watching circuit 66 of the power patch panel module 4 recognizes the pulsed signal and illuminates the mapping indicator 68. The technician, after activating the switch 54, can go to the power patch panel and look at the various modules for a lit indicator 68. This provides a simple arrangement for allowing a technician to effectively map a network. The user patch terminal 6 does not convert signals as the time out function has been activated by the pulsed signal.

FIG. 4 also includes the watch circuit 56 and it is possible for the power patch panel module 4 to also include an activation mechanism for sending a pulsed signal. In this way, a particular power patch panel module 4 could be activated and the mapping indicator 58 would be illuminated.

From the above, it can be appreciated that the network mapping function is based on the use of a secondary communication path established using two control characteristics of current optical transceivers. When a transceiver receives an idle level of light from the opposite end of a fiber link, a “signal detect (SD)” signal becomes active at the receiving end. The transceiver also includes a TX Disable signal, and when this signal is made active at the transmitting end, it shuts down the transmitting element in the transceiver so that the idle level of light is removed. In normal operation the TX Disable is inactive, and the transceiver increases and decreases the light level around the idle point to transmit Ethernet packets of information. Also in the normal operation at the receive end, the SD signal remains active, signaling that the idle level of light is present and that digital data can be received.

The structure of the present invention provides for secondary communication by switching the TX Disable signal at a certain rate and duty cycle so that the signal detect line at the other end of the path switches in a light pattern. As soon as the receiving transceiver SD signal goes inactive, all Ethernet communication is ceased, and the system waits for it to reestablish after a predetermined time period. During this time period, the pulsing SD line is ignored by the Ethernet processing arrangement, but used by the network mapping function to send and receive serial number and position data. In the simple command and illuminate function, locate LEDs can show maintenance staff the opposite end of an optical link by pulsing TX Disable at the end in question. In a more sophisticated application, the network mapping function can include a table showing the connectivity of a large network, and can be presented in a table format. The present system is also capable of being automated and the particular patch panels can be instructed to determine a connected location patch terminal, and have the patch terminal transmit location information. Thus, with the above it is possible to provide automated mapping function in addition to the manual mapping function as previously described.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. In a fiber to copper patch terminal operating using a protocol for controlling an optical transceiver for transmission and detection of signals and including a Tx Disable function that has an inactive and an active state, said Tx Disable function in said active state causing said optical transceiver to interrupt transmission of light and produce a condition where Ethernet communication has ceased and requires resetting, said Tx Disable function in said inactive state allowing resetting and Ethernet communication; and
wherein said patch terminal includes a selectively activated location identification function, said location identification function when activated causing said optical transceiver to transmit a location signal during a period where Ethernet communication is awaiting resetting.

2. In a patch terminal as claimed in claim 1 wherein said location identification function causes said Tx Disable function to alternate between active and inactive states.

3. In a patch terminal as claimed in claim 2 wherein said location identification function causes said Tx Disable function to pulse between said active and inactive states at a rate to maintain said condition where Ethernet communication has ceased and requires resetting.

4. In a patch terminal as claimed in claim 1 wherein said location identification function is selectively activated by a manual switch provided on said patch terminal.

5. In a patch terminal as claimed in claim 2 wherein said location identification function is selectively activated by a manual switch provided on said patch terminal.

6. In a patch terminal as claimed in claim 3 wherein said location identification function is selectively activated by a manual switch provided on said patch terminal.

7. In a patch terminal as claimed in claim 4 wherein said location identification function transmits an address signal in said location signal.

8. In a patch terminal as claimed in claim 5 wherein said location identification function transmits an address signal in said location signal.

9. In a patch terminal as claimed in claim 6 wherein said location identification function transmits an address signal in said location signal.

10. A fiber optic network system comprising a power patch panel having a series of modules connected to a series of fiber to copper user patch terminals by fiber optic cabling, said power panel patch modules each including a plurality of ports and each port includes an indicator that is activated upon receipt of a location identification transmission signal originating from a connected user patch terminal;
each user patch terminal including an optical transceiver that transmits and receives signals in accordance with a communication protocol that includes a non transmit/receive period if a detected interruption in communication with an associated power patch panel module has occurred,
each user patch terminal including a selectively activated location identification function that when activated causes said user patch terminal to produce a non transmit/receive period recognized by the protocol, said location identification function causing said optical transceiver to transmit an identification signal;
said associated power patch panel module, upon receipt of a location identification signal, producing a visual indication identifying the port that received the location identification signal.

11. A fiber optic network system as claimed in claim 10 wherein said power patch panel module includes a light source associated with each port that is activated when a location identification signal is received by the respective port.

12. A fiber optic network system as claimed in claim 11 wherein said location identification function of each patch terminal includes a manual switch which produces said location identification signal when activated.

13. A fiber optic network system as claimed in claim 12 wherein said communication protocol is an Ethernet communication protocol.

14. A fiber optic network system as claimed in claim 12 wherein said communication protocol includes a resettable time interruption period where signals received by said user patch panels are not processed according to said communication protocol, said resettable time interruption period being initiated when an idle level of light is not received by the respective transceiver.

15. A fiber optic network system as claimed in claim 14 wherein said manual switch when activated causes said transceiver to pulse between states producing at least an idle level of light to a state not producing an idle level of light sufficient to maintain a state where signals of said transceiver are not processed using said communication protocol.

16. In a fiber to copper patch terminal the improvement including operating protocol for controlling an optical transceiver for transmission and reception of signals and including selectively activated circuitry that when activated produces a condition wherein normal communication with a connected power patch panel module is temporarily interrupted;
said circuitry during interruption of normal communication causing said transceiver to transmit a location identification signal recognizable by said power panel module.

17. A fiber to copper patch panel terminal as claimed in claim 16 wherein said selectively activated circuitry controls said transceiver to continue to produce a condition where Ethernet communication protocol to maintain temporary interruption of normal communication until said selectively activated circuitry is turned off restoring normal communication.
